(19) United States
(12) Patent Application Publication
(10) Pub. No.: US 2024/0062532 A1
(43) Pub. Date: Feb. 22, 2024

(54) SYSTEM AND METHOD FOR LOCAL SPATIAL FEATURE POOLING FOR FINE-GRAINED REPRESENTATION LEARNING

(71) Applicant: CARNEGIE MELLON UNIVERSITY, Pittsburgh, PA (US)

(72) Inventors: Marios SAVVIDES, Pittsburgh, PA (US); Uzair AHMED, Pittsburgh, PA (US); Thanh Hai PHAN, Pittsburgh, PA (US)

(21) Appl. No.: 18/259,479

(22) PCT Filed: Feb. 16, 2022
(86) PCT No.: PCT/US2022/016505

§ 371 Date: Jun. 27, 2023

Related U.S. Application Data
(60) Provisional application No. 63/149,714, filed on Feb. 16, 2021.

(51) Int. Cl. G06V 10/80; G06V 10/82; G06V 10/77; G06V 10/46

(52) U.S. Cl. CPC G06V 10/806; G06V 10/82; G06V 10/7715; G06V 10/462

(57) ABSTRACT

Disclosed herein is a system and method for pooling local features for fine-grained image classification. The deep features learned by the deep network are augmented with low level local landmark features by learning a pooling strategy that pools landmark features from earlier layers of the deep network. These low level landmark features are combined with the deep features and sent to the classifier.

### RELATED APPLICATIONS

This application claims the benefit of U.S. Provisional Patent Application No. 63/149,714, filed Feb. 16, 2021, the contents of which are incorporated herein in their entirety.

### BACKGROUND

Deep neural networks trained with large datasets are relatively adept at distinguishing between basic classes wherein the classes define objects that vary greatly in visual, shape, size and overall appearance. For example, a deep neural network trained on a dataset containing images depicting dogs and planes can easily identify a dog or a plane and can distinguish between them.

However, it is more difficult under these circumstances for the deep neural network to recognize sub-classes of objects, which requires recognition at a fine-grained level. For example, while the network may be able to identify and distinguish a dog from a plane, it may be more difficult for the network to distinguish one breed of dog from another. Deep neural networks perform exceptionally well in learning a generalized image representation but, in the process, may ignore some of the low level details in the image. These low level details gain discriminative importance when the images are mostly similar except for the low level differences.

For example, most dog breeds share common characteristics (i.e., 4 legs, tail, snout, etc.) and have the same general appearance. The sub-class-level recognition problem differs from the basic-level tasks in that the differences between object sub-classes are more subtle. As such, distinguishing sub-classes of objects requires training at a more fine-grained level. Fine-grained object recognition concerns the identification of the type of an object from among a large number of closely related sub-classes of the object class.

Many large datasets used for training deep neural networks for object detection tasks, for example, OpenImages v4 (600 classes of objects) and MS COCO (80 object classes) may have many images of objects in particular, diverse classes. However, examples of variations between objects in a particular class (i.e., sub-classes of objects) may not present in great numbers in the training dataset, with each variation having only a few samples.

### SUMMARY

Disclosed herein is a system and method for performing representation learning by augmenting global image features with spatially pooled local features for fine-grained image classification. The deep features learned by the deep network are augmented with low-level landmark features by learning a pooling strategy that pools landmark features from earlier layers of the deep network. These low level landmark features combined with the deep features result in a better discriminative representation able to classify similar but different objects with improved precision.

### BRIEF DESCRIPTION OF THE DRAWINGS

By way of example, a specific exemplary embodiment of the disclosed system and method will now be described, with reference to the accompanying drawings, in which:

FIG. 1 is a block diagram showing the architecture implemented by the disclosed method.

FIG. 2 is a flow diagram showing the steps of the disclosed method.

### DETAILED DESCRIPTION

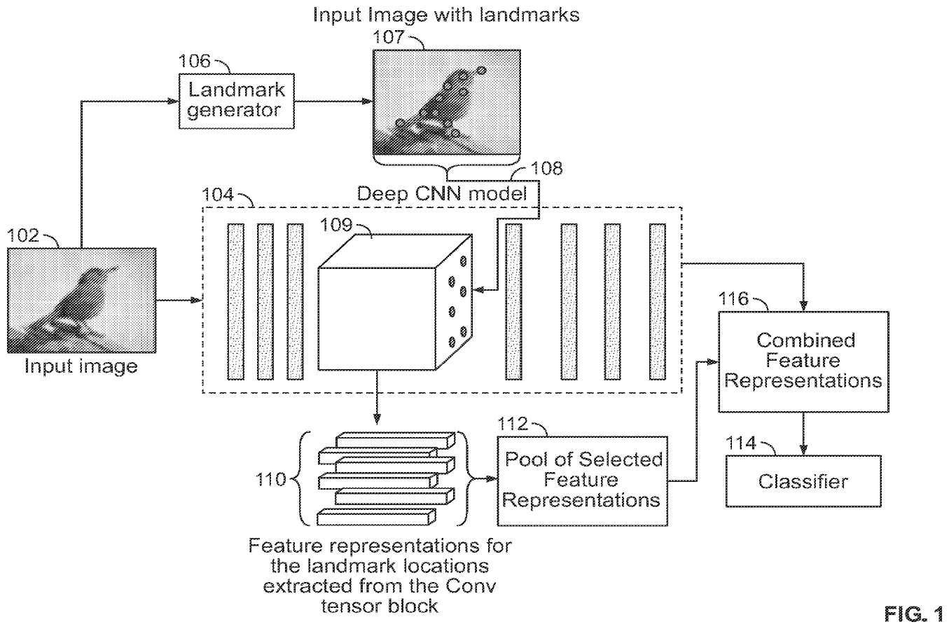

A high level overview of the disclosed method is shown in the FIG. 1. The main goal is to be able to improve representation learning for fine-grained recognition tasks by leveraging local features that add more structural information to the learned feature representation at the end of the deep network.

In this method, input image 102, in addition to being passed through the Deep CNN model 104 is also passed through a landmark generator 106 to generate key landmarks 107 on the input image (see dots on image in FIG. 1) that possess key fine-grained information about the structure of the object. The landmark generator 106 can be, in some embodiments, a CNN model which is pretrained already or which has been jointly trained with the classifier. The images can be annotated with landmarks and used as a dataset to train the landmark detector.

Within the deep model 104, after several convolutional layers, these landmark locations are mapped 108 on the output feature maps 109 of an intermediate convolutional layer within deep model 104. In the embodiment shown in FIG. 1, this occurs after the first 3 convolutional layers, but this may vary in other embodiments.

Because the spatial dimensions of the image are preserved, this allows for a direct mapping 108 of the locations 107 of the key landmarks on the convolutional map in relation to the image pixel locations. A local feature representation 110 (e.g., channel×1×1) at each mapped landmark location 108 is then extracted from the convolutional tensor block 109 and passed through a pooling block 112 wherein the most robust local feature representations are selected using a weighting scheme learned during the model training. In one embodiment, the weighting scheme may assign weights, which may be learned, for example, based on the ability of particular local feature representations 110 to discriminate between sub-classes. In a preferred embodiment, only the top-k local feature representations corresponding to the top-k weights are selected, and the rest are discarded, wherein k is a variable parameter which may be explicitly specified or learned by determining an optimal number of local feature representations needed to distinguish sub-classes.

In alternate embodiments, the selection step may be optional and all of the local feature representations 110 may be used. In yet other alternate embodiments, other methods may be used to select the local feature representations 110. For example, the model may be explicitly instructed which local feature representations 110 to select based on domain knowledge.

The selected local feature representations 110 are combined with the global feature representations learned at the deepest layer in the deep CNN Model 104 and the combined feature representation 116 is then passed to the classifier 114. In one embodiment, the combining is accomplished by a simple concatenation, but in other embodiments, other methods of combining may also be used.

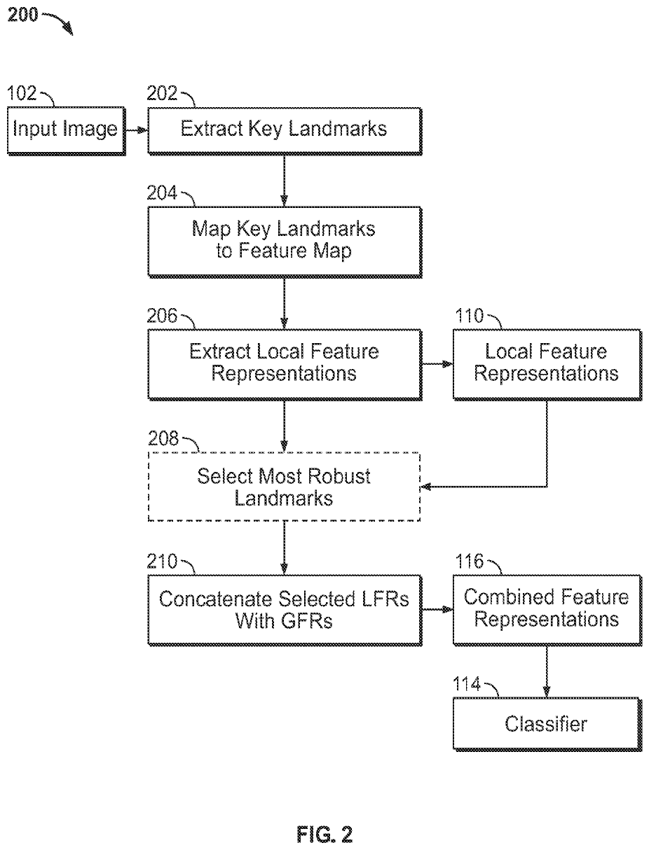

FIG. 2 is a flowchart depicting the steps of the disclosed method of the invention. Image 102 is input to the landmark generator 106 and the landmarks are extracted at step 202. At step 204, the landmarks are mapped to a feature map from an intermediate convolutional layer within the deep CNN model 104. At step 206, local feature representations 110 are extracted from the convolutional tensor block 109 of the deep CNN model 104. The extracted local feature representations 110 are sent to pooling block 112 at step 208 where a selection is made (as previously described) of those local feature representations 110 which are to be combined with global feature representations. At step 210, the selected local feature representations 110 are combined with the global feature representations from deep CNN model 104 to create combined feature representations 116. Preferably, the combined feature representations 116 are created by concatenating local feature representations 110 with the global feature representations. The combined feature representations 116 are then sent to classifier 114.

Although the flowchart of FIG. 2 does not depict the steps of the training of the various convolutional layers within deep CNN network 104 when presented with input image 110, as would be realized by one of skill in the art, the various layers of the CNN network 104 are trained in a conventional manner to produce the global feature representations which are then combined with the local feature representations 110 to create the combined feature representations 116.

As would be realized by one of skill in the art, the disclosed method described herein can be implemented by a system comprising a processor and memory, storing software that, when executed by the processor, performs the functions comprising the method.

As would further be realized by one of skill in the art, many variations on implementations discussed herein which fall within the scope of the invention are possible. Moreover, it is to be understood that the features of the various embodiments described herein were not mutually exclusive and can exist in various combinations and permutations, even if such combinations or permutations were not made express herein, without departing from the spirit and scope of the invention. Accordingly, the method and apparatus disclosed herein are not to be taken as limitations on the invention but as an illustration thereof. The scope of the invention is defined by the claims which follow.

1. A method comprising:
extracting key local landmarks from an input image;
mapping the key local landmarks to a feature map of an intermediate convolutional layer of a deep CNN model;
extracting local feature representations of the key landmarks from the locations of the mapped key local landmarks on the feature map; and
combining all or some of the local feature representations with global feature representations produced by the deep CNN model to create combined feature representations.

2. The method of claim 1 further comprising:
sending the combined feature representations to a classifier to be used to classify objects in the input image.

3. The method of claim 1 further comprising:
selecting a subset of the local feature representations to be combined with the global feature representations.

4. The method of claim 3 wherein the subset of local feature representations is selected based on a weighting scheme wherein a predetermined number of higher-weighted local feature representations are selected.

5. The method of claim 3 wherein the weighting scheme is a learned weighting scheme.

6. The method of claim 5 wherein the learned weighting scheme assigns weights depending on the ability of the local feature representations to discriminate between objects in the input image belonging to different subclasses.

7. The method of claim 4 wherein the predetermined number is a learned number.

8. The method of claim 7 wherein the predetermined number is learned based on an optimal number of local feature presentations needed to discriminate between sub-classes.

9. The method of claim 3 when the subset of local feature representations are selected based on explicit knowledge of a domain of objects depicted in the input image.

10. The method of claim 1 wherein the local feature representations are combined with the global feature representations by concatenation.

11. The method of claim 1 wherein the key landmarks in the input image are mapped to the feature map after the third convolutional layer of the deep CNN model.

12. The method of claim 1 wherein extracting key local landmarks from an input image comprises exposing the input image to a CNN model trained with a dataset comprising images with annotated landmarks.

13. A system comprising:
a processor; and
memory, storing software that, when executed by the processor, performs the method of claim 1.

14. A system comprising:
a processor; and
memory, storing software that, when executed by the processor, performs the method of claim 4.
